(19) United States
(12) Patent Application Publication
(10) Pub. No.: US 2006/0193126 A1
(43) Pub. Date: Aug. 31, 2006

(54) Solar-powered enclosure

(76) Inventors: Gregory G. Kuelbs, Westlake, TX (US); Gustav P. Kuelbs, Grapevine, TX (US); Keith E. Taber, Dallas, TX (US)

Correspondence Address: LAW OFFICES OF JAMES E. WALTON, PLLC, 1169 N. BURLESON BLVD., SUITE 107-328, BURLESON, TX, 76028, US

(21) Appl. No.: 11/362,976

(22) Filed: Feb. 27, 2006

Related U.S. Application Data
(60) Provisional application No. 60/656,515, filed on Feb. 25, 2005.
(60) Provisional application No. 60/692,169, filed on Jun. 20, 2005.

(51) Int. Cl. F21V 33/00

(52) U.S. Cl. 362/155

(57) ABSTRACT

A solar-powered enclosure having solar energy system for powering an electrical subsystem is disclosed. The electrical subsystem may include lighting elements for illuminating the enclosure and the area around the enclosure in a decorative and functional manner.

This application claims the benefit of U.S. Provisional Application No. 60/656,515, filed 25 Feb. 2005, titled “SOLAR POWERED COOLER.” This application also claims the benefit of U.S. Provisional Application No. 60/692,169, filed 20 Jun. 2005, titled “SOLAR-POWERED STORAGE BOX.”

### BACKGROUND OF THE INVENTION

1. Field of the Invention

The present invention relates in general to the field of enclosures.

2. Description of Related Art

There are many designs of enclosures well known in the art. However there remains room for improvement upon current enclosure designs. Enclosures including coolers, toolboxes, and storage boxes all stand to be improved.

For example, some coolers are used to serve refreshments or other items outdoors at night or in otherwise poorly illuminated spaces where the user of the cooler may not be able to visually inspect the interior of the cooler. Because the user cannot visually inspect the interior of the cooler, he is unable to easily visually locate the item he desires to remove from the interior of the cooler. Also, many cooler designs inconveniently require a user to stoop or otherwise bend downward from a standing position to reach the interior of the cooler. While there are many coolers well known in the art, considerable room for improvement remains.

Similarly, some toolboxes and storage boxes are used to retain tools, equipment, supplies and/or other items while the toolboxes and/or storage boxes are located outdoors at night or in otherwise poorly illuminated spaces where the user of the cooler may not be able to visually inspect the interior of the cooler. Because the user cannot visually inspect the interior of the toolbox and/or storage box, he is unable to easily visually locate the item he desires to remove from the interior of the enclosure. While there are many toolboxes and storage boxes well known in the art, considerable room for improvements remains.

### SUMMARY OF THE INVENTION

There is a need for a safer and more convenient enclosures.

Therefore, it is an object of the present invention to provide a safer and more convenient enclosure, having features allowing the user to easily implement and utilize the enclosure.

This object is achieved by providing an enclosure having a solar energy system for illuminating the enclosure.

The present invention provides significant advantages, including: (1) allowing visual inspection of the enclosure interior when the enclosure is located in a poorly illuminated space allowing for proper selection and retrieval of items therein; (2) reducing the difficulty and risk of physical injury related to reaching into the interior of the enclosure and retrieving objects, such as stooping to lift heavy items from the enclosure interior; and (3) increasing safety by minimizing risk of physical injuries related to reaching into an unilluminated enclosure, such as grasping broken glass.

Further objects and advantages of this invention will become apparent from a consideration of the drawings and ensuing description.

### BRIEF DESCRIPTION OF THE DRAWINGS

For a more complete understanding of the present invention, including its features and advantages, reference is now made to the detailed description of the invention taken in conjunction with the accompanying drawings in which like numerals identify like parts, and in which:

FIG. 1A is a perspective view of the preferred embodiment of a cooler system according to the present invention;

FIG. 1B is a perspective view of the cooler system of FIG. 1A;

FIG. 2 is a high level schematic of the solar energy system of the cooler system of FIG. 1A;

FIG. 3 is a perspective view of an alternate embodiment of a cooler system according to the present invention;

FIG. 4 is a perspective view of another alternate embodiment of a cooler system according to the present invention;

FIG. 5 is a perspective view of another alternate embodiment of a cooler system according to the present invention;

FIG. 6 is a perspective view of the preferred embodiment of a toolbox system according to the present invention;

FIG. 7A is a perspective view of the preferred embodiment of a solar-powered storage box according to the present invention;

FIG. 7B is a side view of the solar-powered storage box according to FIG. 7A; and

FIG. 7C is a perspective view of the solar-powered storage box according to FIG. 7A.

### DETAILED DESCRIPTION OF THE PREFERRED EMBODIMENT

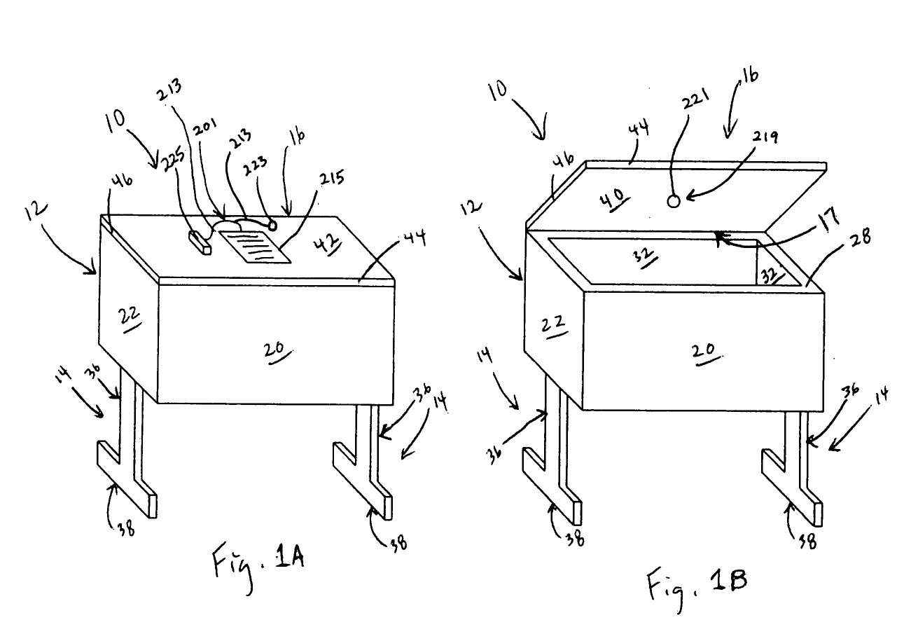

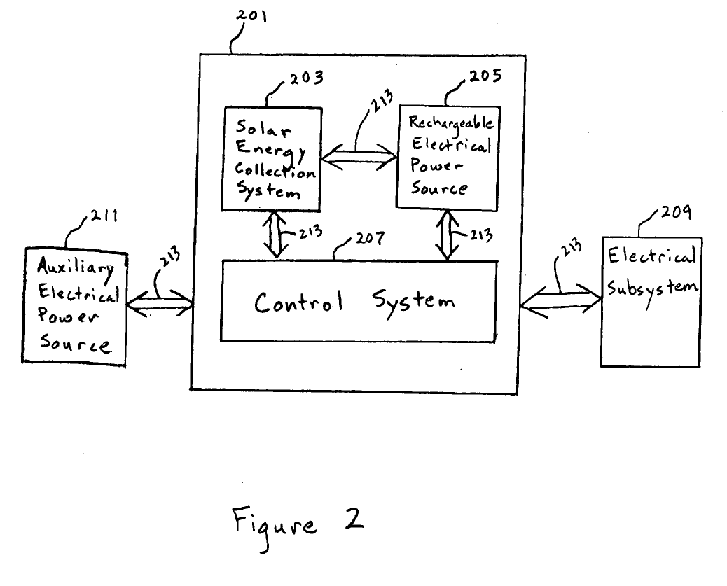

Referring now to FIGS. 1A and 1B in the drawings, the preferred embodiment according to the present invention is illustrated as a cooler system 10. Cooler system 10 preferably comprises a body 12, a plurality of support members 14, at least one lid 16, at least one hinge 17, and at least one solar energy system 201. Body 12 preferably comprises a front wall 20, a left wall 22, a rear wall (not shown), a right wall (not shown), a top wall 28, a bottom wall (not shown), a plurality of interior walls 32, and an interior floor (not shown). Each support member 14 preferably comprises a vertical portion 36 and a horizontal portion 38. Lid 16 preferably comprises a lid bottom 40, a lid top 42, a lid front wall 44, a lid left wall 46, a lid rear wall (not shown), and a lid right wall (not shown).

Body 12 is preferably constructed of plastic but may alternately be constructed of metal, glass, wood, or any other suitable material. Front wall 20, left wall 22, rear wall, right wall, top wall 28, bottom wall, interior walls 32, and interior floor are all preferably rectangular in shape but may alternately be shaped in any other suitable manner. The space between interior walls 32 and each of front wall 20, left wall 22, rear wall, and right wall is preferably filled with a material having thermal insulating properties suitable for limiting the transfer of heat energy therethrough. The space between interior floor and bottom wall is also preferably filled with a material having thermal insulating properties suitable for limiting the transfer of heat energy therethrough.

Support members 14 are preferably attached to bottom wall. Support members 14 are preferably constructed of metal but may alternately be constructed of wood, plastic, or any other suitable material for supporting body 12. Vertical portion 36 serves to substantially elevate body 12 from the surface on which cooler system 10 is resting. Vertical portion 36 is preferably attached to bottom wall and to horizontal portion 38. Horizontal portion 38 provides additional structural support for body 12. Alternate embodiments may include support members 14 of a single pedestal, one or more “L” shaped members, or any other suitable design for supporting body 12.

Preferably attached to body 12 along rear wall is hinge 17. Hinge 17 is also attached to lid 16 along lid rear wall. Hinge 17 allows lid 16 to move relative to body 12. Hinge 17 may alternately be connected to lid 16 and body 12 in any other manner and at any other location suitable for providing a moveable connection between lid 16 and body 12. Hinge 17 is preferably constructed of metal but may alternately be constructed of plastic, wood, leather, or any other suitable material. In an alternate embodiment, the cooler system may consist of more than one lid where lids are attached to the body 12 in a manner such that the lids cooperate to offer a variety of options with regard to accessing the interior of the body. Additionally, in other embodiments of the cooler system, lids may alternatively be slidably connected to the body, removably connected to the body, simply placed onto the body, or altogether absent from the cooler system. Lid 16 is preferably constructed of plastic but may alternatively be constructed of metal, wood, glass, or any other suitable material.

Now referring to FIG. 2, the preferred embodiment of solar energy system 201 according to the present invention is illustrated. Solar energy system 201 preferably comprises a solar energy collection system 203, a rechargeable electrical power source 205, and a control system 207. Solar energy system 201 is preferably conductively coupled to an electrical subsystem 209. Solar energy system 201 may optionally be conductively coupled to an auxiliary electrical power source 211. Conductive coupling is preferably achieved through the use of electrical conductors 213 such as insulated copper wires, circuit boards, or other suitable devices or means for conductively coupling electrical components.

Solar energy collection system 203 preferably comprises a solar collector 215 (see FIG. 1A) and other necessary circuitry for receiving and collecting solar energy and converting the solar energy into electrical energy. Solar energy collection system 203 is preferably conductively coupled to both rechargeable electrical power source 205 and control system 207 with electrical conductors 213. Rechargeable electrical power source 205 preferably comprises a rechargeable battery for storing electrical energy; however, rechargeable electrical power source 205 may alternatively comprise any rechargeable electrical power storage device, such as a capacitor, battery pack, any other suitable device for storing electrical energy, or combination thereof. Rechargeable electrical power source 205 is preferably conductively coupled to solar energy collection system 203 and control system 207 with electrical conductors 213.

The purpose of solar energy system 201 is preferably to convert solar energy into electrical energy and to supply that electrical energy to one or more electrical subsystems 209. In operation, solar energy collection system 203 preferably converts solar energy into electrical energy. Solar energy collection system 203 preferably delivers electrical energy to rechargeable electrical power source 205 to provide a trickle charge to rechargeable electrical power source 205. However, when rechargeable electrical power source 205 is fully charged, solar energy collection system 203 preferably delivers electrical energy to control system 207 where the electrical energy is preferably diverted for uses other than charging rechargeable electrical power source 205. For example, the electrical energy could be used to directly power electrical subsystem 209 rather than electrical subsystem 209 consuming power from rechargeable electrical power source 205.

Auxiliary electrical power source 211 preferably comprises an alternating current power source such as power from a conventional AC outlet; however, auxiliary electrical power source 211 may alternatively comprise a direct current power source such as a non-rechargeable battery, one or more fuel cells, a renewable energy source such as a wind powered generator, a rechargeable battery pack (in which the battery pack is removed, recharged remotely, and thereafter replaced back into auxiliary electrical power source 211), or any other electrical power source-suitable for providing solar energy system 201 with additional electrical energy. Of course, the foregoing configuration allows for the interchanging, or swapping, of battery packs. Auxiliary electrical power source 211 is preferably conductively coupled to solar energy system 201 and preferably delivers electrical energy to control system 207. Auxiliary electrical power source 211 preferably supplies electrical energy for a variety of uses including: powering electrical subsystem 209, recharging rechargeable electrical power source 205, and powering other solar energy system 201 circuitry such as control system 207.

Alternative embodiments of solar energy system 201 may not include the solar energy collection system 203. Instead, solar energy system 201 may comprise a circuit for powering electrical subsystem 209 operable only by electrical energy supplied by auxiliary electrical power source 211.

Control system 207 preferably comprises circuitry, microprocessors, memory devices, sensors, switches, and other electronic components necessary to: partially or fully direct electrical energy from solar energy collection system 203 to rechargeable electrical power source 205, fully or partially direct electrical energy from solar energy collection system 203 to electrical subsystem 209, allow a user to manually switch solar energy system 201 on and off, receive input to alter or control the performance of the recharging of rechargeable electrical power source 205 and/or the supply of electrical energy to electrical subsystems 209, control the performance of electrical subsystems 209, fully or partially charge rechargeable electrical power source 205 with electrical energy supplied by auxiliary electrical power source 211, and fully or partially power electrical subsystem 209 with electrical energy from auxiliary power source 211. For example, control system 207 may alternatively comprise a micro-switch operably associated with lid 16 in a manner such that when lid 16 is opened, power is supplied to electrical subsystem 209.

It will be appreciated that while solar energy system 201 comprises control system 207 in this preferred embodiment, simpler and less sophisticated embodiments of solar energy system 201 are possible. For example, solar energy system 201 may not comprise-control system 207, but merely comprise solar energy collection system 203 and rechargeable electrical power source 205 conductively coupled to each other with electrical conductors 213.

As illustrated in FIG. 1B, electrical subsystem 209 is preferably a lighting subsystem 219 for providing illumination. Lighting subsystem 219 preferably comprises lighting elements 221 conductively coupled to solar energy system 201. Lighting elements 221 are preferably light emitting diodes (LEDs), but may be organic light emitting diodes, incandescent bulbs, cold cathode ray tubes, fluorescent lights, or any other suitable electrical lighting apparatus, or combination thereof. It will be appreciated that the electrical subsystem 209 of alternate embodiments of the present invention may be a water pumping subsystem, sound subsystem, video subsystem, microphone subsystem, receiving and transmitting subsystem, motion actuating subsystem, cooling subsystem, heating subsystem, raising and lowering subsystem, water agitation subsystem, electrical motor subsystem, any other electrically powered subsystem, or combination thereof.

A translucent shield, a lens, reflector, light fixture, or a combination of these may optionally be attached to or operably associated with lighting subsystem 219 to enhance or alter the illumination provided by lighting elements 221. The optional shields, lenses, reflectors, and fixtures may also be configured to prevent water, dirt, or other particulate matter from interfering with the operation of lighting elements 219. Further, it will be appreciated that the optional shields, lenses, reflectors, and fixtures may be incorporated into any embodiment of the present invention.

It will be appreciated that lighting subsystem 219 and control system 207 may include selected components, circuitry, and microprocessor control chips to produce a variety of optional features. For example, optional features may include: manual lighting intensity controls, blinking lights, fading lights, changing the light color, motion activated lighting, sound activated lighting, a wide variety of lighting sequence or motion effects, and any other appropriate lighting effects or interactive means for controlling lighting effects. Of course, any components, circuitry, microprocessor control chips, or other means of controlling or altering the functionality of electrical subsystem 209 would be conductively coupled to solar energy system 201, electrical subsystem 209, and/or auxiliary electrical power source 211. Further, where electrical subsystem 209 is not a lighting subsystem 219, it will be appreciated that similar controls, programming capabilities, interactive input devices, and other electrical subsystem 209 performance controls or alteration means may be incorporated into the electrical subsystem 209 and/or the associated control system 207.

A photo resistor, or photo cell 223 (see FIG. 1A), is preferably incorporated into the preferred embodiment of control system 207. Photo cell 223 detects the presence of light and controls whether lighting elements 221 provide illumination, by switching lighting elements 221 on or off, or by regulating the intensity of light provided by lighting elements 221. For example, when photo cell 223 detects a substantial amount of light, lighting elements 221 are switched off and provide no illumination. However, when photo cell 223 detects a low level of light, lighting elements 221 are switched on and provide illumination. Alternatively, photo cell 223 may be used to dim or brighten the output of lighting elements 221. In addition, one or more on-off switches or buttons may be incorporated into control system 207 to facilitate the operation of solar energy system 201, or to vary the operation and control of solar energy system 201, auxiliary electrical power source 211, or electrical subsystem 209. It will be appreciated that the operation of solar energy system 201, auxiliary electrical power source 211, and electrical subsystem 209 may be controlled remotely by infrared light, radio wave, or other types of transmitters and receivers.

It will be appreciated that solar energy system 201 may further comprise or be conductively coupled to a connection port for conveniently interfacing solar energy system 201 with other components, systems, subsystems, or any other suitable devices. The connection port is preferably conductively coupled with control system 207; however, connection port may alternatively be conductively coupled to any other component of solar energy system 201, auxiliary electrical power source 211, or electrical subsystem 209. More specifically, connection ports may be adapted to interface with electrical devices electrical devices having power plugs compatible with the connection port. Connection ports would be a great convenience because electrical devices such as lights, fans, radios, or other suitable electrical devices could be supplied power or controlled by solar energy system when connected to the connection port.

Components of solar energy system 201, auxiliary electrical power source 211, and electrical subsystem 209 may be located substantially near each other. For example, in the preferred embodiment, with the exceptions of solar collectors 215, photo cell 223, and lighting elements 221, much of the circuitry of solar energy system 201, auxiliary electrical power source 211, and electrical subsystem 209 is preferably substantially housed within an enclosure 225 (see FIG. 1). It will be appreciated that the components of solar energy system 201, auxiliary electrical power source 211, and electrical subsystem 209 are preferably substantially protected such that water, dirt, and other matter is prevented from interfering with the operation of solar energy system 201, auxiliary electrical power source 211, and electrical subsystem 209. It should also be appreciated that in alternative embodiments, components of solar energy system 201, auxiliary electrical power source 211, and electrical subsystem 209 may not be housed in enclosure 225 and may be located substantial distances from each other while remaining conductively coupled. For example, an alternative embodiment of the present invention may be configured such that solar collector 215 is located on a home rooftop and is conductively coupled to rechargeable electrical power source 205, other components, systems, and/or subsystems which are located a significant distance away from solar collector 215, such as near the ground level of the home.

It will be appreciated that enclosure 225 may alternatively be adapted to carry all or substantially all of the components of solar energy system 201, electrical subsystem 209, and auxiliary electrical power source 211. In alternative embodiments of the present invention, enclosure 225 may be shaped and adapted for easy connection to and disconnection from the structure supporting enclosure 225. For example, an embodiment of enclosure 225 may allow enclosure 225 to be removably attached to the structure supporting enclosure 225, subsequently detached from the structure, and later removably attached to a different supporting structure. Alternatively, enclosure 225 may be integrally or sealably attach to a supporting structure. For example, enclosure 225 may be attached such that it passes through a hole in a supporting structure and forms a watertight seal with that hole. Further, enclosure 225 may alternatively be attached to different types of structures or embodiments of the present invention suitable for supporting or carrying enclosure 225.

Components of solar energy system 201, auxiliary electrical power source 211, and electrical subsystem 209 may located and/or operably associated with various locations on each embodiment of cooler system, including in the body, in the support members, and in the lids. Additionally, components of solar energy system 201, auxiliary electrical power source 211, and electrical subsystem 209 systems may be located remote from and even significantly distant from each cooler. Enclosure 225 is preferably located on lid top 42; however, it will be appreciated that in some embodiments of the present invention, one or more components of solar energy system 201 may be located remote from lid top 42.

Solar collector 215 may be located at any suitable location on or about the cooler or remote from the cooler; however, it is preferred that solar collector 215 be optimally exposed to solar light. Solar collector 215 is preferably attached to lid top 42, but may alternately be located remote from lid top 42. For those applications in which cooler system 10 is primarily a decorative piece and/or is displayed indoors, it may be desirable to locate solar collector 215 at a location on cooler system 10 that is near or faces a window, or at a location remote from the cooler where the remote location may have different ambient lighting conditions. For example, if bird bath is located indoors with low levels of light available for conversion to electrical energy by solar collector 215, solar collector 215 may be located outdoors to expose solar collector 215 to more light. It will be understood that sufficiently long electrical conductors 213 are incorporated to achieve remote placement of solar collectors 215 and other remotely located electrical components. For similar reasons, photo cell 223 is also preferably attached to lid top 42, but may alternately be located remote from lid top 42.

Lighting elements 221 are preferably attached to lid bottom 40. Lighting elements 221 may also optionally be operably associated with other locations on the cooler, support members 14, or even remote from the cooler and support members 14. Lighting elements 221 preferably illuminate the interior of the cooler and/or the space in and around the cooler. Specifically, lighting elements 221 are preferably connected to lid bottom 42 and arranged to illuminate the interior of the cooler in a manner such that the interior of the cooler is sufficiently illuminated to allow visual inspection of the interior of the cooler. It will be appreciated that lighting elements 221 may alternatively be located remote from the cooler such that lighting elements 221 provide illuminations to spaces significantly remote from the cooler. For example, multiple lighting elements 221 may be located remote from the cooler so that the remotely located lighting elements 221 illuminate a path or walkway leading to the cooler.

It will be appreciated that some structural elements of cooler system 10 may alternatively be constructed of optically conductive material such as glass or a translucent plastic. Where structural elements of cooler system 10 are constructed of an optically conductive material, lighting elements 221 may be located within the optically conductive material, thereby optionally creating a glowing illumination effect.

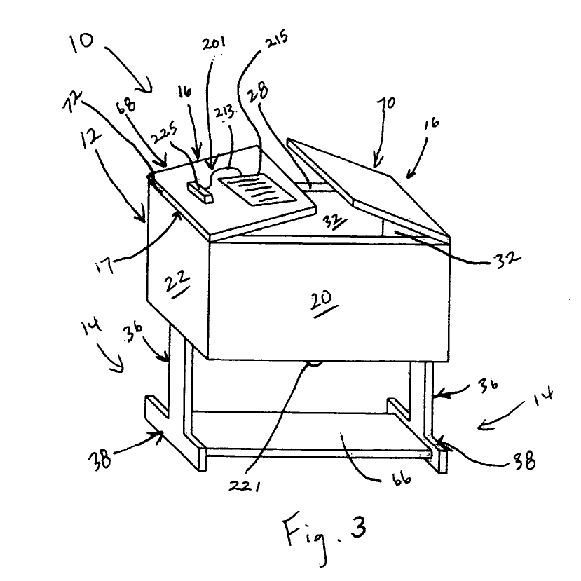

Referring now to FIG. 3 in the drawings, an alternative embodiment of the present invention is illustrated as a cooler system 10. This alternate embodiment comprises all of the elements of the preferred embodiment but further comprises an optional shelf 66 and notably comprises multiple lids 16, hinges 17, and lighting elements 221. In this embodiment, a left lid 68 comprises a left face 72 and a right lid 70 comprises a right face (not shown). A hinge 17 is connected to left face 72 of left lid 68 and also to left wall 22 of body 12, thereby moveably connecting left lid 68 to body 12. Another hinge 17 is connected to right face of right lid 70 and also to right wall of body 12, thereby moveably connecting right lid 70 to body 12. At least one lighting element 221 is attached to lid 16 in a manner that illuminates the space between walls 32.

Hinges 17 may alternately be connected to lids 16 and body 12 in any other manner and at any other location suitable for providing a moveable connection between lids 16 and body 12. Placement of solar energy system 201 in this alternate embodiment is substantially similar to the placement of solar energy system 201 in the preferred embodiment. Optional shelf 66 is preferably attached to support members 14 in a manner that provides a substantially level surface. Optional shelf 66 is preferably constructed of plastic but may alternately be constructed of metal, wood, glass, or any other suitable material. At least one lighting element 221 is attached to body 12 or a support member 14 such that optional shelf 66 is substantially illuminated.

Referring now to FIG. 4 in the drawings, an alternative embodiment of the present invention is illustrated as a cooler system 10. This alternate embodiment comprises all of the elements of the preferred embodiment but notably comprises multiple lids 16, hinges 17, and lighting elements 221. In this embodiment, left lid 68 comprises a left back face (not shown) and right lid 70 comprises a right back face (not shown). A hinge 17 is connected to left back face and also to rear wall of body 12, thereby moveably connecting left lid 68 to body 12. Another hinge 17 is connected to right back face and also to rear wall of body 12, thereby moveably connecting right lid 70 to body 12. Hinges 17 may alternately be connected to lids 16 and body 12 in any other manner and at any other location suitable for providing a moveable connection between lids 16 and body 12. Placement of solar energy system 201 in this alternate embodiment is substantially similar to the placement of solar energy system 201 in the preferred embodiment. At least one lighting element 221 is attached to each lid 16 in a manner that illuminates the space between walls 32.

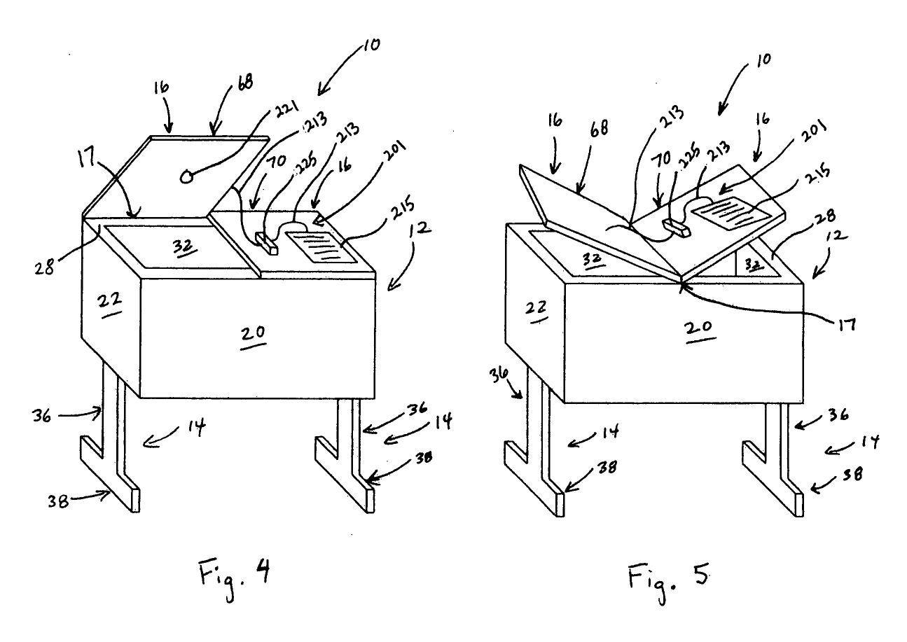

Referring now to FIG. 5 in the drawings, an alternative embodiment of the present invention is illustrated as a cooler system 10. This alternate embodiment comprises all of the elements of the preferred embodiment but notably comprises multiple lids 16, hinges 17, and lighting elements 60. In this embodiment, left lid 68 comprises a right lid face (not shown) and right lid 70 comprises a left lid face (not shown). A hinge 17 is connected to right lid face and also to top wall 28 of body 12, thereby moveably connecting left lid 68 to body 12. Another hinge 17 is connected to right back face and also to top wall 28 of body 12, thereby moveably connecting right lid 70 to body 12. Hinges 17 may alternately be connected to lids 16 and body 12 in any other manner and at any other location suitable for providing a moveable connection between lids 16 and body 12. In this embodiment, hinges 17 are located substantially centered between left wall 22 and right wall. Placement of solar energy system 201 in this alternate embodiment is substantially similar to the placement of solar energy system 201 in the preferred embodiment. At least one lighting element 221 is attached to each lid 16 in a manner that illuminates the space between walls 32.

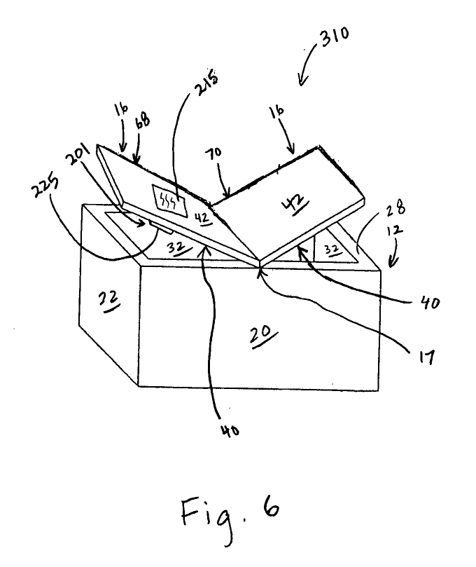

Referring now to FIG. 6 in the drawings, an alternative embodiment of the present invention is illustrated as a toolbox system 310. This alternate embodiment is substantially similar to the alternate embodiment illustrated in FIG. 5 but with three notable differences. First, toolbox system 310 comprises no support members and is adapted to allow installation of toolbox system 310 into the bed of a typical pickup truck. Second, body 12 may not be thermally insulated. Third, enclosure 225 is preferably attached to a lid bottom 40 rather than a lid top 42 or within the lid 16.

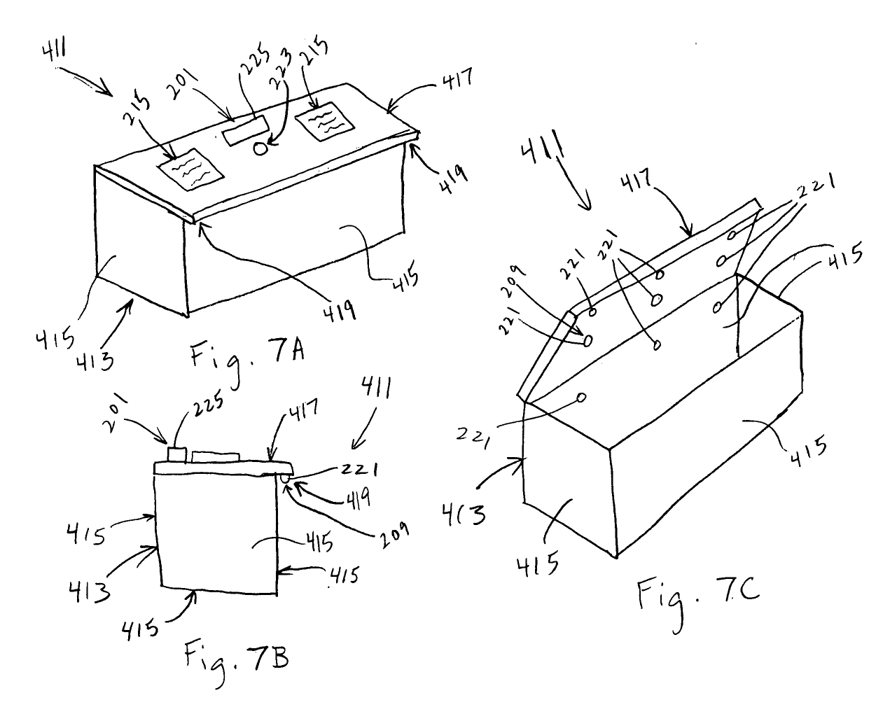

Referring now to FIGS. 7A-7C in the drawings, the preferred embodiment of a solar-powered storage box 411 according to the present invention is illustrated. Box 411 is illustrated as having a box structure 413 and a solar energy system 201 (see FIG. 2). Box structure is illustrated as being a substantially enclosed structure having walls 415 and at least one lid 417. Of course, box structure 413 alternatively may not include lid 417 but rather be open without a lid. Lid 417 is illustrated as having a lip 419 which at least partially extends beyond the front wall of box structure 413. Box structure 413 is illustrated as being a semi-permanent structure; however, box structure 413 may alternatively be adapted for modular folding and easy storage. Of course box structure 413 may be shaped, sized, and constructed in a myriad of ways. For example, box structure may alternatively have an number of other lid configurations such as having multiple lids, sliding lids, lift off lids, and rotating lids, to name just a few. Lid 417 is illustrated as being attached to a rear wall 415 with a conventional hinge, allowing for selective lifting and lowering of lid 417 subsequently allowing access to the interior of box structure 413. FIGS. 7A and 7B illustrated lid 417 in a closed position while FIG. 7C illustrates lid 417 in an open position.

Solar energy collection system 203 preferably comprises a solar collector 215 (see FIGS. 7A-7C) and other necessary circuitry for receiving and collecting solar energy and converting the solar energy into electrical energy.

As illustrated in FIGS. 7A-7C, electrical subsystem 209 is preferably a lighting subsystem 219 for providing illumination. A photo resistor, or photo cell 223 (see FIG. 7A), is preferably incorporated into the preferred embodiment of control system 207.

Components of solar energy system 201, auxiliary electrical power source 211, and electrical subsystem 209 may be located substantially near each other. For example, in the preferred embodiment, with the exceptions of solar collectors 215, photo cell 223, and lighting elements 221, much of the circuitry of solar energy system 201, auxiliary electrical power source 211, and electrical subsystem 209 is preferably substantially housed within an enclosure 225 (see FIGS. 7A-7B).

It will be appreciated that in alternative embodiments where the enclosure carries the entire solar energy system and/or other circuitry or systems, the enclosure may be inset, inlaid, or disposed in a recessed space of the supporting structure. For example, a wall 415 may have a space cut out for fully or partially receiving enclosure 225 whereby lighting elements 221 may illuminate storage box 411 from a recessed area of the wall. Enclosure 225 may be similarly situated in other box structure 413 elements, such as lid 417, or optional shelves (not shown). Further, enclosure 225 may alternatively be attached to different types of structures or embodiments of the present invention suitable for supporting or carrying enclosure 225.

Components of solar energy system 201, auxiliary electrical power source 211, and electrical subsystem 209 may located and/or operably associated with various locations on each embodiment of box 411, including in the walls 415, lid 417, optional shelves (not shown), and/or in any other element of box structure 413. Additionally, components of solar energy system 201, auxiliary electrical power source 211, and electrical subsystem 209 systems may be located remote from and even significantly distant from each box structure 413. Enclosure 225 is preferably located on lid 417; however, it will be appreciated that in some embodiments of the present invention, one or more components of solar energy system 201 may be located remote from lid 417.

Solar collector 215 may be located at any suitable location on or about box structure 413 or remote from box structure 413; however, it is preferred that solar collector 215 be optimally exposed to solar light. Solar collector 215 is preferably attached to an exterior face of lid 417, but may alternately be located remote from lid 417. For those applications in which box structure 413 is primarily a decorative piece displayed indoors, it may be desirable to locate solar collector 215 at a location on box structure 413 that is near or faces a window, or at a location remote from box structure 413 where the remote location may have different ambient lighting conditions. For example, if box structure 413 is located indoors with low levels of light available for conversion to electrical energy by solar collector 215, solar collector 215 may be located outdoors to expose solar collector 215 to more light. It will be understood that sufficiently long electrical conductors 213 are incorporated to achieve remote placement of solar collectors 215 and other remotely located electrical components. For similar reasons, photo cell 223 is also preferably attached to an exterior face of lid 417, but may alternately be located remote from lid 417.

Lighting elements 221 are preferably attached lip 419, a bottom face of lid 417, and the interior faces of walls 415. Lighting elements 221 may also optionally be operably associated with any other portion of box structure suitably for carrying lighting elements 221. Lighting elements 221 preferably illuminate box 411 and/or the space in and around box 411. Specifically, lighting elements 221 are preferably connected lid 417 and arranged to illuminate box 411 in a manner such that an interior volume of box 413 is substantially illuminated. It will be appreciated that lighting elements 221 may alternatively be located remote from box structure 413 such that lighting elements 221 provide illumination to spaces significantly remote from box structure 413. For example, multiple lighting elements 221 may be located remote from box structure 413 so that the remotely located lighting elements 221 illuminate a path or walkway leading to box structure 413.

It will be appreciated that box structure 413 may alternatively be constructed of optically conductive material such as glass or a translucent plastic. Where an element of box 413 is constructed of an optically conductive material, lighting elements 221 may be located within the optically conductive component, thereby optionally creating a glowing illumination effect.

In alternative embodiments, multiple lighting elements may be located on or about storage box 411. The multiple lighting elements 221 may be arranged in a manner such that the lighting elements 221 illuminate with strips of illumination. Further, alternate embodiments of storage box may include more than one solar energy system to independently power multiple lighting elements.

It will be appreciated that electrical components may optionally be incorporated into solar energy system 201 so as to allow for a variety of functional and/or decorative results. For example, a motion sensor (not shown) may be used to sense an approaching user of box 411 such that lighting elements 221 illuminate an area around and/or an area remote to box structure 413. Further, an electronic switching means operated by opening/closing lid 417 may be incorporated to conserve electrical energy by switching off any lighting elements 221 arranged to illuminate the exterior of box structure 413 and/or other exterior space while switching on any lighting elements 221 arranged to illuminate the interior space of box structure 413.

It will be appreciated that any embodiment of the present invention may incorporate partition walls within the body to create partitions within the body. Where partition walls are incorporated into an embodiment, lighting elements are preferably located and oriented to illuminate each separate partitioned space within the body.

While this invention has been described with reference to an illustrative embodiment, this description is not intended to be construed in a limiting sense. Various modifications and other embodiments of the invention will be apparent to persons skilled in the art upon reference to the description.

We claim:

1. A cooler, comprising:
a portable and thermally insulated body having an opening and an interior volume;
an electrical subsystem operably associated with the cooler; and
a solar energy system conductively coupled to the electrical subsystem, the solar energy system comprising:
a rechargeable electrical power source; and
a solar energy collection system conductively coupled to the rechargeable electrical power source for recharging the rechargeable electrical power source.

2. The cooler according to claim 1, wherein the electrical subsystem is a lighting system.

3. The cooler according to claim 1, further comprising:
at least one support member attached to the body for vertically supporting the body.

4. The cooler according to claim 3, further comprising:
at least one shelf attached to the at least one supporting member.

5. The cooler according to claim 2, further comprising:
at least one lid adapted to cover the opening.

6. The cooler according to claim 5, wherein the lighting system is activated by moving the at least one lid relative to the body.

7. The cooler according to claim 2, wherein the lighting system illuminates the volume.

8. The cooler according to claim 2, wherein the lighting system illuminates a space near the cooler.

9. The cooler according to claim 2, wherein the lighting system further comprises: at least one lighting element, wherein the at least one lighting element is chosen from the group of light emitting diodes, organic light emitting diodes, cold cathode ray tubes, fluorescent lights, incandescent bulbs, and neon bulbs.

10. The cooler according to claim 2, wherein the cooler further comprises:
a means for selectively activating the lighting system.

11. The cooler according to claim 1, wherein the rechargeable electrical power source comprises at least one of the group including a rechargeable battery, a removable rechargeable battery pack, and a fuel cell.

12. The cooler according to claim 1, wherein the rechargeable electrical power source is adapted to be recharged by a source of alternating current.

13. The cooler according to claim 1, wherein the electrical subsystem is selected from the group consisting of sound subsystems, video subsystems, cooling subsystems, heating subsystems, water pumping subsystems, microphone subsystems, receiving and transmitting subsystems, motion actuating subsystems, water agitation subsystems, electrical motor subsystems, and combinations thereof.

14. A solar light module for illuminating enclosures, comprising:
a solar energy system carried by the solar light module, the solar energy system comprising:
a rechargeable electrical power source; and
a solar energy collection system conductively coupled to the rechargeable electrical power source for recharging the rechargeable electrical power source;
at least one lighting element for providing illuminating the enclosure, the lighting element being conductively coupled to the solar energy system; and
a means for releasably connecting the solar light module to the enclosure.

15. The solar light module according to claim 14, further comprising:
a translucent shield for protecting the lighting elements.

16. The solar light module according to claim 14, further comprising:
a translucent shield for protecting the lighting elements, the shield being adapted to reflect the light from the lighting elements.

17. The solar light module according to claim 14, further comprising:
a reflector operably associated with the shield for reflecting the light from the lighting elements.

18. The solar light module according to claim 14, wherein the rechargeable electrical power source includes at least one rechargeable battery.

19. The solar light module according to claim 14, wherein the rechargeable electrical power source includes at least one rechargeable battery pack adapted for remote recharging.

20. The solar light module according to claim 14, wherein the rechargeable electrical power source is adapted for recharging from an alternating current outlet.

21. The solar light module according to claim 14, wherein the rechargeable electrical power source is adapted for recharging from a fuel cell.

22. The solar light module according to claim 14, wherein the at least one lighting element is a light emitting diode.

23. The solar light module according to claim 14, wherein the at least one lighting element is selected from the group consisting of organic light emitting diodes, cold cathode ray tubes, fluorescent bulbs, incandescent bulbs, and combinations thereof.
